(19) United States
(12) Patent Application Publication
(10) Pub. No.: US 2009/0083096 A1
(43) Pub. Date: Mar. 26, 2009

(54) Handling product reviews

(75) Inventors: Yunbo Cao, Beijing (CN); Chin-Yew Lin, El Segundo, CA (US); Ming Zhou, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/903,153

(22) Filed: Sep. 20, 2007

(51) Int. Cl. G06Q 99/00

(52) U.S. Cl. 705/7

(57) ABSTRACT

A method for handling product reviews can detect a first quality product review from a second quality product review. The first and second quality product reviews can be associated with a product. The first quality product review can be filtered. An opinion segment in the second quality product review can be identified and the polarity can be determined of the opinion segment. An opinion set can be generated with the opinion segment for a product feature. A score (or weighty can be aggregated of segments in the opinion set for the product feature.

### BACKGROUND

Users of online shopping sites can generate and post online reviews corresponding to different products. Leveraging these product reviews to provide a better shopping experience for users is of strategic importance for online shopping service providers. For example, online shopping service providers can enable online users the ability to read product reviews posted by previous purchasers in order to determine whether or not to purchase a particular product. However, when hundreds of product reviews have been posted for that particular product, utilizing all of them can become an overwhelming task. In order to deal with this problem, an application referred to as an opinion summarization can be utilized. Opinion summarization of product reviews is an application in which sentiments articulated in product reviews are extracted and presented with respect to each feature (e.g. image quality) of a certain product (e.g., Digital Camera Y). Additionally, opinion summarization keeps track of the number of positive posted opinions and the number of negative posted opinions related to that certain product. However, there are disadvantages associated with the opinion summarization. For example, the quality of each of the posted reviews can vary greatly. As such, the results provided by the opinion summarization may not be an accurate representation of the posted reviews associated with that certain product.

As such, it is desirable to address one or more of the above issues.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method for handling product reviews can detect a first quality product review from a second quality product review. The first and second quality product reviews can be associated with a product. The first quality product review can be filtered. An opinion segment in the second quality product review can be identified and the polarity can be determined of the opinion segment. An opinion set can be generated with the opinion segment for a product feature. A score (or weight) can be aggregated of segments in the opinion set for the product feature.

Such a method for handling product reviews can produce more accurate opinion summarization of product reviews. In this manner, the production of opinion summarizations of product reviews can be enhanced.

### DESCRIPTION OF THE DRAWINGS

FIG. 1 is a block diagram of an example computer system used in accordance with embodiments of the present technology for handling product reviews.

FIG. 2 is an example flow diagram of operations performed in accordance with one embodiment of the present technology.

FIG. 3 is another example flow diagram of operations performed in accordance with an embodiment of the present technology.

FIG. 4 is a block diagram of an example system for handling product reviews, according to an embodiment of the present technology.

### DETAILED DESCRIPTION

Reference will now be made in detail to embodiments of the present technology for handling product reviews, examples of which are illustrated in the accompanying drawings. While the technology for handling product reviews will be described in conjunction with various embodiments, it will be understood that they are not intended to limit the present technology for handling product reviews to these embodiments. On the contrary, the presented embodiments of the technology for handling product reviews are intended to cover alternatives, modifications and equivalents, which may be included within the scope of the various embodiments as defined by the appended claims. Furthermore, in the following detailed description, numerous specific details are set forth in order to provide a thorough understanding of embodiments of the present technology for handling product reviews. However, embodiments of the present technology for handling product reviews may be practiced without these specific details. In other instances, well known methods, procedures, components, and circuits have not been described in detail as not to unnecessarily obscure aspects of the present embodiments.

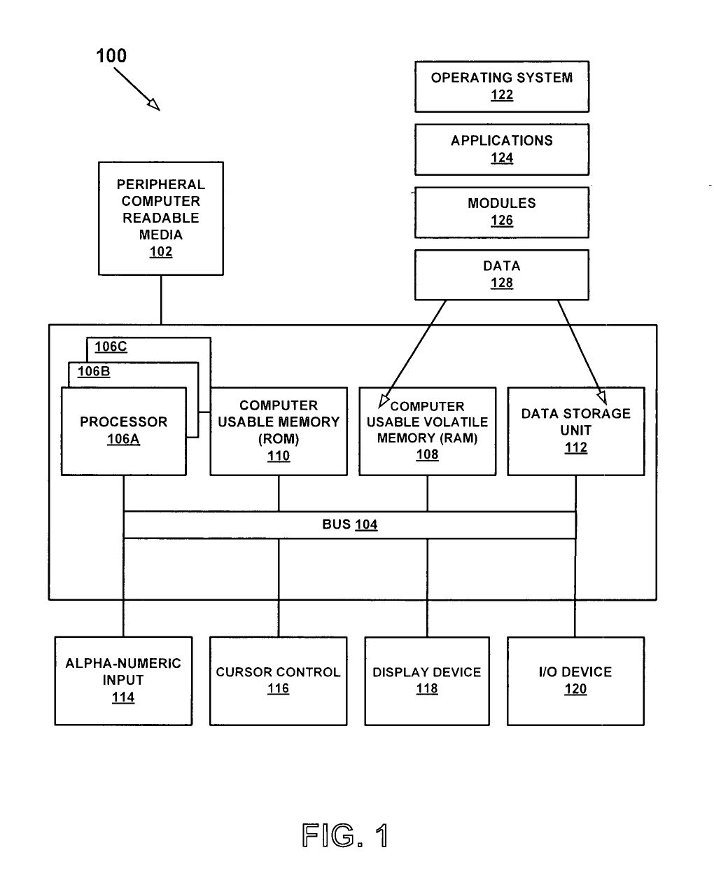

Unless specifically stated otherwise as apparent from the following discussions, it is appreciated that throughout the present detailed description, discussions utilizing terms such as “detecting”, “filtering”, “identifying”, “aggregating”, “receiving”, “generating”, “determining”, “performing”, “translating”, “utilizing”, “presenting”, “incorporating”, “producing”, “retrieving”, “outputting”, or the like, refer to the actions and processes of a computer system (such as computer 100 of FIG. 1), or similar electronic computing device. In one embodiment, the computer system or similar electronic computing device can manipulate and transform data represented as physical (electronic) quantities within the computer system's registers and/or memories into other data similarly represented as physical quantities within the computer system memories and/or registers or other such information storage, transmission, or display devices. Some embodiments of the present technology for handling product reviews are also well suited to the use of other computer systems such as, for example, optical and virtual computers.

### Example Computer System Environment

With reference now to FIG. 1, all or portions of some embodiments of the technology for handling product reviews are composed of computer-readable and computer-executable instructions that reside, for example, in computer-usable media of a computer system. That is, FIG. 1 illustrates one example of a type of computer that can be used to implement embodiments, which are discussed below, of the present technology for handling product reviews. FIG. 1 illustrates an example computer system 100 used in accordance with embodiments of the present technology for handling product reviews. It is appreciated that system 100 of FIG. 1 is only an example and that embodiments of the present technology for handling product reviews can operate on or within a number of different computer systems including general purpose networked computer systems, embedded computer systems, routers, switches, server devices, client devices, various intermediate devices/nodes, stand alone computer systems, media centers, handheld computer systems, low-cost computer systems, high-end computer systems, and the like. As shown in FIG. 1, computer system 100 of FIG. 1 is well adapted to having peripheral computer readable media 102 such as, for example, a floppy disk, a compact disc, a DVD, and the like coupled thereto.

System 100 of FIG. 1 can include an address/data bus 104 for communicating information, and a processor 106A coupled to bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 can also includes data storage features such as a computer usable volatile memory 108, e.g. random access memory (RAM), coupled to bus 104 for storing information and instructions for processors 106A, 106B, and 106C. System 100 also includes computer usable non-volatile memory 110, e.g. read only memory (ROM), coupled to bus 104 for storing static information and instructions for processors 106A, 106B, and 106C. Also present in system 100 is a data storage unit 112 (e.g., a magnetic or optical disk and disk drive) coupled to bus 104 for storing information and instructions. System 100 can also include an optional alphanumeric input device 114 including alphanumeric and function keys coupled to bus 104 for communicating information and command selections to processor 106A or processors 106A, 106B, and 106C. System 100 can also include an optional cursor control device 116 coupled to bus 104 for communicating user input information and command selections to processor 106A or processors 106A, 106B, and 106C. System 100 of the present embodiment can also include an optional display device 118 coupled to bus 104 for displaying information.

Referring still to FIG. 1, optional display device 118 may be a liquid crystal device, cathode ray tube, plasma display device or other display device suitable for creating graphic images and alphanumeric characters recognizable to a user. Optional cursor control device 116 allows the computer user to dynamically signal the movement of a visible symbol (e.g., cursor) on a display screen of display device 118 and indicate user selections of selectable items displayed on display device 118. Many implementations of cursor control device 116 are known in the art including a trackball, mouse, touch pad, joystick or special keys on alpha-numeric input device 114 capable of signaling movement of a given direction or manner of displacement. Alternatively, it is pointed out that a cursor can be directed and/or activated via input from alpha-numeric input device 114 using special keys and key sequence commands. System 100 is also well suited to having a cursor directed by other means such as, for example, voice commands. System 100 can also include an input/output (I/O) device 120 for coupling system 100 with external entities. For example, in one embodiment, I/O device 120 can be a modem for enabling wired and/or wireless communications between system 100 and an external network such as, but not limited to the Internet.

Referring still to FIG. 1, various other components are depicted for system 100. In embodiments of the present technology, operating system 122 is a modular operating system that is comprised of a foundational base and optional installable features which may be installed in whole or in part, depending upon the capabilities of a particular computer system and desired operation of the computer system. Specifically, when present, all or portions of operating system 122, applications 124, modules 126, and data 128 are shown as typically residing in one or some combination of computer usable volatile memory 108, e.g. random access memory (RAM), and data storage unit 112. However, it is appreciated that in some embodiments, operating system 122 may be stored in other locations such as on a network or on a flash drive (e.g., 102); and that further, operating system 122 may be accessed from a remote location via, for example, a coupling to the internet. In some embodiments, for example, all or part of the present technology for handling product reviews can be stored as an application 124 or module 126 in memory locations within RAM 108, media within data storage unit 112, and/or media of peripheral computer readable media 102. Likewise, in some embodiments, all or part of the present technology for handling product reviews may be stored at a separate location from computer 100 and accessed via, for example, a coupling to one or more networks or the internet.

### Example Methods of Operation

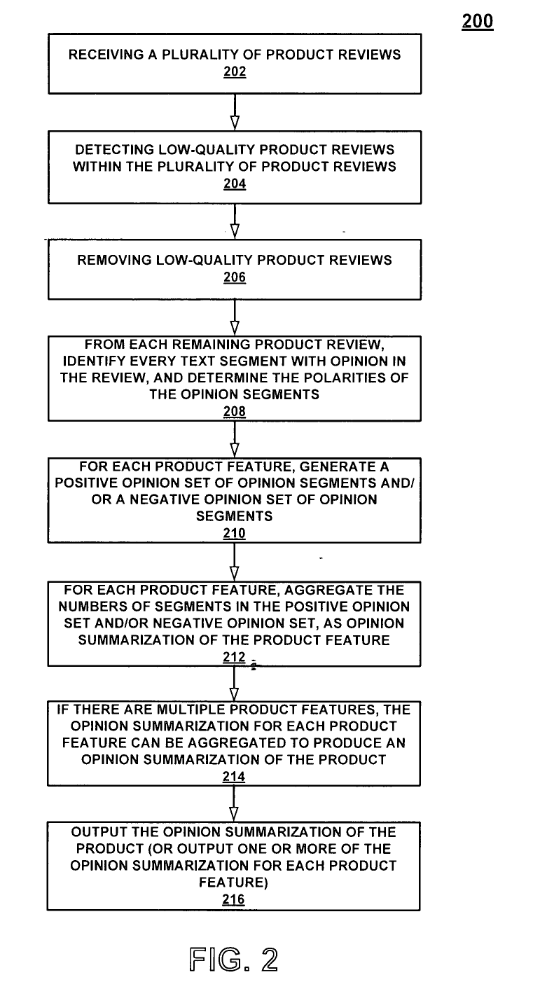

The following discussion sets forth in detail the operation of some example methods of operation of embodiments of the present technology for handling product reviews. FIG. 2 is a flow diagram of an example method 200 for handling product reviews in accordance with various embodiments of the present technology. Flow diagram 200 includes processes that, in various embodiments, are carried out by a processor(s) under the control of computer-readable and computer-executable instructions (or code), e.g., software. The computer-readable and computer-executable instructions (or code) may reside, for example, in data storage features such as computer usable volatile memory 108, computer usable non-volatile memory 110, peripheral computer-readable media 102, and/or data storage unit 112 of FIG. 1. The computer-readable and computer-executable instructions (or code), which may reside on computer useable media, are used to control or operate in conjunction with, for example, processor 106A and/or processors 106A, 106B, and 106C of FIG. 1. However, the computing device readable and executable instructions (or code) may reside in any type of computing device readable medium. Although specific operations are disclosed in flow diagram 200, such operations are examples. Method 200 may not include all of the operations illustrated by FIG. 2. Also, embodiments are well suited to performing various other operations or variations of the operations recited in flow diagram 200. Likewise, the sequence of the operations of flow diagrams 200 can be modified. It is appreciated that not all of the operations in flow diagram 200 may be performed. It is noted that the operations of method 200 can be performed by software, by firmware, by electronic hardware, by electrical hardware, or by any combination thereof.

It is pointed out that process 200 can involve a two-stage approach to enhance the reliability of opinion summarization. For example, a process of low-quality review detection and removal can be included before an opinion summarization process, so that the summarization result is obtained on the basis of high-quality reviews. Specifically, method 200 can include receiving a plurality of product reviews associated with a product. Low-quality product reviews can be detected within the plurality of product reviews. The low-quality product reviews can be removed. From each of the remaining product reviews, every text segment with an opinion in the review can be identified, and the polarities can be determined of the opinion segments. For each product feature, a positive opinion set of opinion segments and/or a negative opinion set of opinion segments can be generated. For each product feature, the numbers (or score) of segments in the positive opinion set and/or negative opinion set can be aggregated, thereby generating an opinion summarization of the product feature. If there are multiple product features, the opinion summarization for each product feature can be aggregated, thereby producing an opinion summarization of the product. The opinion summarization of the product can be output. In one embodiment, one or more of the opinion summarization for each product feature can be output.

At operation 202 of FIG. 2, one or more product reviews pertaining to a product can be received or retrieved from a source. It is noted that operation 202 can be implemented in a wide variety of ways. For example in an embodiment, the one or more product reviews can be received or retrieved at operation 202 from one or more web sites that reside on one or more networks (e.g., the Internet). In one embodiment, the one or more product reviews can be received or retrieved at operation 202 from an intermediary associated with one or more web sites that reside on one or more networks (e.g., the Internet). Operation 202 can be implemented in any manner similar to that described herein, but is not limited to such.

At operation 204, low-quality product reviews can be detected within the one or more product reviews. It is pointed out that operation 204 can be implemented in a wide variety of ways. For example in an embodiment, at operation 204, four categories of review quality can be utilized to represent the different values of reviews to users' purchase decision: “best review”, “good review”, “fair review”, and “bad review”. In one embodiment, the first three categories (“best”, “good” and “fair”) can be treated as high-quality reviews while those in the “bad” category can be treated as low-quality reviews that should not be considered in creating product review summaries.

Specifically in an embodiment, a “best” review can be a rather complete and detailed comment on a product. It can present several features (or aspects) of the product and provide convincing opinions with sufficient evidence. A “best” review may be taken as the main reference (or only recommendation) that users read before making their purchasing decision on a certain product. The “best” review can also be formatted well for readers to easily understand. Additionally in one embodiment, a “good” review can be a relatively complete comment on a product, but not with as much supporting evidence as desired. The “good” review could be used as a strong and influential reference, but not as the only recommendation. Furthermore in one embodiment, a “fair” review can contain a very brief description on a product. It does not supply detailed evaluation on the product, but only comments on one or more features (or aspects) of the product. Moreover in an embodiment, a “bad” review can usually be an incorrect description of a product with misleading information. It may include little about a specific product but much on some general topics related to the product. A “bad” review an be an unhelpful review that can be ignored. Also, a “bad” review may not describe any features of the product.

In one embodiment of operation 204 of FIG. 2, a statistical machine learning approach or technique can be employed to detect low-quality products reviews. For example, given a training data set: D={xᵢ, yᵢ}₁ⁿ, a model can be constructed that can minimize error in prediction of y given x (generalization error). Note that xᵢεX and yᵢ={high quality, low quality} represents a product review and a label, respectively. When applied to a new instance x, the model can predict the corresponding y and can output the score of the prediction. In one embodiment, in order to differentiate low-quality product reviews from high-quality ones, the task can be treated as a binary classification.

It is noted that a SVM (Support Vector Machines), ME (Maximum Entropy), NBC (Naïve Bayesian Classifier), Logistic Regression, AdaBoost, and/or the like can be employed as the classification model at operation 204, but is not limited to such. For example in one embodiment, a SVM can be employed at operation 204 as the model of classification. Specifically, given an instance x (product review), SVM can assign a score to it based on:

f(x)=w^{T}x+b (1)

where w can denote a vector of weights and b can denotes an intercept. It is noted that the higher the value of f(x) is, the higher the quality of the instance x is. In classification, the sign of f(x) can be used in an embodiment. For example, if it is positive, then x can be classified into the positive category (high-quality reviews), otherwise it can be classified into the negative category (low-quality reviews). In one embodiment, the construction of SVM can involve labeled training data (e.g., the categories can be “high-quality reviews” and “low-quality reviews”). Note that the learning algorithm can create the “hyper plane” in (1), such that the hyper plane separates the positive and negative instances in the training data with the largest “margin”.

Within operation 204 of FIG. 2, it is pointed out that product features (e.g., “image quality” for a digital camera) in a product review can be good indicators of review quality. However, two or more different product features mentioned in the product reviews may actually refer to the same product feature (e.g., “battery life” and “power”), which can bring redundancy to the opinion summarization produced by process 200 since the opinion summarization can be organized around the product features. Note that this problem can be referred to as the “resolution of product features”. Thus, the problem can be reduced to how to determine the equivalence of a product feature in different forms.

In an embodiment, this problem can be resolved by leveraging two kinds of evidence within the product reviews: one is “surface string” evidence, and the other is “contextual evidence”. Specifically in one embodiment, an edit distance can be utilized to compare the similarity between the surface strings of two product feature mentions, and utilize contextual similarity to reflect the semantic similarity between two product feature mentions. In an embodiment, surface string evidence or contextual evidence can be utilized to determine the equivalence of a product feature in different forms.

Within operation 204 of FIG. 2, when using contextual similarity in an embodiment, all the reviews can be split into sentences. For each mention of a product feature, it can be taken as a query and search for all the relevant sentences. Then a vector can be constructed for the product feature mention, by taking each unique term in the relevant sentences as a dimension of the vector. The cosine similarity between two vectors of product feature mentions can then be present to measure the contextual similarity between the two mentions.

To detect low-quality reviews at operation 204, in one embodiment, an approach can explore three aspects of product reviews, namely informativeness, subjectiveness, and readability. It is pointed out that the features employed for learning can be denoted as “learning features”, discriminative from “product features” discussed herein. Specifically in an embodiment, as for informativeness, the resolution of product features can be employed when generating the example learning features as listed below. Note that pairs mapping to the same product feature can be treated as the same product feature, when calculating the frequency and number of product features. Furthermore, a list of product names and a list of brand names can be utilized in generating the learning features. In one embodiment, the following can be the learning features on informativeness of a review:
Sentence Level (SL)
   The number of sentences in the review;
   The average length of sentences; and/or
   The number of sentences with product features.
Word Level (WL)
   The number of words in the review;
   The number of products in the review;
   The number of products in the title of a review;
   The number of brand names in the review; and/or
   The number of brand names in the title of a review.
Product Feature Level (PFL)
   The number of product features in the review;
   The total frequency of product features in the review;
   The average frequency of product features in the review;
   The number of product features in the title of a review; and/or
   The total frequency of product features in the title of a review.

Within FIG. 2, regarding readability at operation 204, in one embodiment several features at the paragraph level can be used to indicate the underlying structure of the product reviews. For example, these features can include:
The number of paragraphs in the review;
The average length of paragraphs in the review; and/or
The number of paragraph separators in the review.
   In an embodiment, it is pointed out that keywords, such as “Pros”, “Cons”, “Strength”, Weakness”, “The Good”, “The Bad”, “Thumb up”, “Bummer”, “Advantages”, “Drawbacks”, “The Upside”, “Downsides”, “Likes”, “Dislikes”, “Good Things”, and “Bad Things” can be referred to as “paragraph separators”. The keywords can usually appear at the beginning of paragraphs for categorizing two contrasting aspects of a product. In one embodiment, the nouns and/or noun phrases at the beginning of each paragraph can be extracted from the product reviews and use those most frequent 30 (or any number) pairs of keywords as paragraph separators.

Regarding subjectiveness at operation 204, in one embodiment a sentiment analysis tool can be used which aggregates a set of shallow syntactic information. The sentiment analysis tool can be a classifier capable of determining the sentiment polarity of each sentence. For example, in an embodiment one or more learning features can be created regarding the subjectiveness of reviews:
The percentage of positive sentences in the review;
The percentage of negative sentences in the review; and/or
The percentage of subjective sentences (regardless of positive or negative) in the review.
   It is pointed out that operation 204 can be implemented in any manner similar to that described herein, but is not limited to such.

At operation 206 of FIG. 2, the low-quality product reviews can be removed or deleted. Note that operation 206 can be implemented in a wide variety of ways. For example in one embodiment, the low-quality product reviews can be removed or deleted at operation 206 from any further processing during process 200. Operation 206 can be implemented in any manner similar to that described herein, but is not limited to such.

At operation 208, from each of the remaining product reviews, every text segment with an opinion in the review can be identified, and the polarities can be determined of the opinion segments. It is noted that operation 208 can be implemented in a wide variety of ways. For example, operation 208 can be implemented in any manner similar to that described herein, but is not limited to such.

At operation 210 of FIG. 2, for each product feature, a positive opinion set of opinion segments and/or a negative opinion set of opinion segments can be generated. It is pointed out that operation 210 can be implemented in a wide variety of ways. For example, operation 210 can be implemented in any manner similar to that described herein, but is not limited to such.

At operation 212, for each product feature, the one or more numbers (or scores) of segments in the positive opinion set and/or negative opinion set can be aggregated, thereby generating an opinion summarization of the product feature. Note that operation 212 can be implemented in a wide variety of ways. For example, operation 212 can be implemented in any manner similar to that described herein, but is not limited to such.

At operation 214 of FIG. 2, if there are multiple product features, the opinion summarization for each product feature can be aggregated, thereby generating an opinion summarization of the product. It is pointed out that operation 214 can be implemented in a wide variety of ways. For example, operation 214 can be implemented in any manner similar to that described herein, but is not limited to such. At operation 214, note that if there is a single product feature, the opinion summarization of the product feature generated at operation 212 can also be the opinion summarization of the product.

At operation 216, the opinion summarization of the product can be output or transmitted. Note that operation 216 can be implemented in a wide variety of ways. For example in one embodiment, the opinion summarization of the product can be output or transmitted at operation 216 to a display device to enable viewing of it. In an embodiment, the opinion summarization of the product can be output or transmitted at operation 216 to a computing device via a network. In one embodiment, the opinion summarization of the product can be output or transmitted at operation 216 to a storage device (e.g., memory). Operation 216 can be implemented in any manner similar to that described herein, but is not limited to such. At the completion of operation 216, process 200 can be exited.

It is pointed out that in one embodiment, operation 214 can be omitted from process 200. As such, at operation 216 of this embodiment, one or more of the opinion summarization for each product feature can be output or transmitted. Note that operation 216 of this embodiment can be implemented in a wide variety of ways. For example in one embodiment, one or more of the opinion summarization for each product feature can be output or transmitted at operation 216 to a display device to enable viewing of it. In an embodiment, one or more of the opinion summarization for each product feature can be output or transmitted at operation 216 to a computing device via a network. In one embodiment, one or more of the opinion summarization for each product feature can be output or transmitted at operation 216 to a storage device (e.g., memory). Operation 216 can be implemented in any manner similar to that described herein, but is not limited to such.

It is pointed out that in one embodiment in accordance with the present technology, operations 208, 210 and 212 of method 200 can be referred to as opinion summarization. In an embodiment, operations 208, 210, 212 and 214 of method 200 can be referred to as opinion summarization.

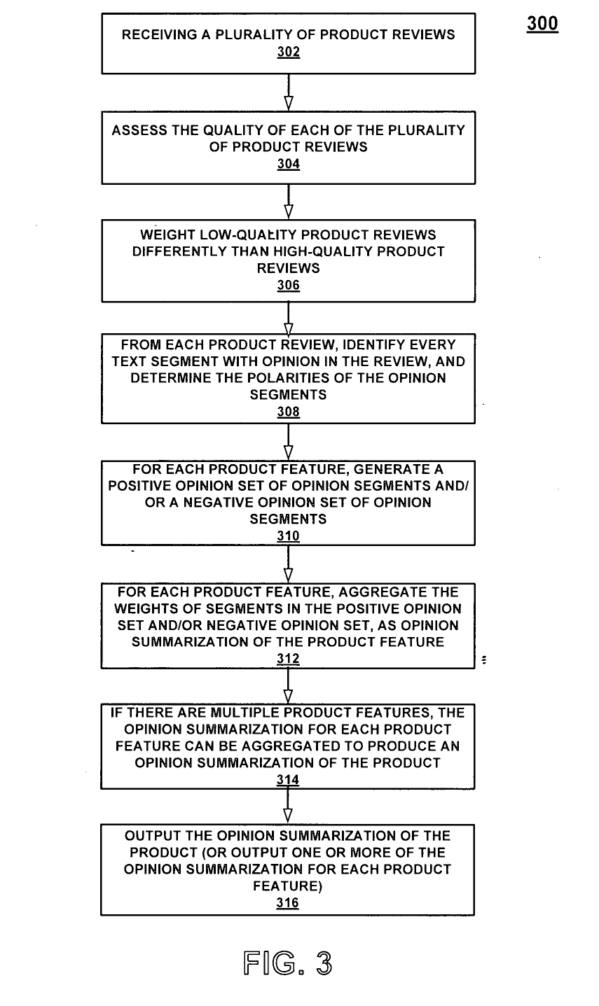

FIG. 3 is a flow diagram of an example method 300 for handling product reviews in accordance with various embodiments of the present technology. Flow diagram 300 includes processes that, in various embodiments, are carried out by a processor(s) under the control of computer-readable and computer-executable instructions (or code), e.g., software. The computer-readable and computer-executable instructions (or code) may reside, for example, in data storage features such as computer usable volatile memory 108, computer usable non-volatile memory 110, peripheral computer-readable media 102, and/or data storage unit 112 of FIG. 1. The computer-readable and computer-executable instructions (or code), which may reside on computer useable media, are used to control or operate in conjunction with, for example, processor 106A and/or processors 106A, 106B, and 106C of FIG. 1. However, the computing device readable and executable instructions (or code) may reside in any type of computing device readable medium. Although specific operations are disclosed in flow diagram 300, such operations are examples. Method 300 may not include all of the operations illustrated by FIG. 3. Also, embodiments are well suited to performing various other operations or variations of the operations recited in flow diagram 300. Likewise, the sequence of the operations of flow diagrams 300 can be modified. It is appreciated that not all of the operations in flow diagram 300 may be performed. It is noted that the operations of method 300 can be performed by software, by firmware, by electronic hardware, by electrical hardware, or by any combination thereof. In one embodiment, one or more of the opinion summarization for each product feature can be output.

It is pointed out that process 300 can involve a two-stage approach to enhance the reliability of opinion summarization. For example, a process of low-quality product review detection and weighting differently can be included before the opinion summarization process, so that the summarization result is obtained on the basis of low-quality reviews weighted differently than high-quality reviews. Specifically, method 300 can include receiving a plurality of product reviews associated with a product. Low-quality product reviews can be detected within the plurality of product reviews. The low-quality product reviews can be weighted differently than high-quality product reviews. From each of the product reviews, every text segment with an opinion in the review can be identified, and the polarities can be determined of the opinion segments. For each product feature, a positive opinion set of opinion segments and/or a negative opinion set of opinion segments can be generated. For each product feature, the weights bf segments in the positive opinion set and/or negative opinion set can be aggregated, thereby generating an opinion summarization of the product feature. If there are multiple product features, the opinion summarization for each product feature can be aggregated, thereby producing an opinion summarization of the product. The opinion summarization of the product can be output.

At operation 302 of FIG. 3, one or more product reviews pertaining to a product can be received or retrieved from a source. It is noted that operation 302 can be implemented in a wide variety of ways. For example in an embodiment, the one or more product reviews can be received or retrieved at operation 302 from one or more web sites that reside on one or more networks (e.g., the Internet). In one embodiment, the one or more product reviews can be received or retrieved at operation 302 from an intermediary associated with one or more web sites that reside on one or more networks (e.g., the Internet). Operation 302 can be implemented in any manner similar to that described herein, but is not limited to such.

At operation 304, the quality can be assessed of each of the one or more product reviews. It is pointed out that operation 304 can be implemented in a wide variety of ways. For example in an embodiment, at operation 304, the quality can be assessed of each of the one or more product reviews in any manner similar to the detecting of the low-quality product reviews within the one or more product reviews, as described herein. Moreover, operation 304 can be implemented in any manner similar to that described herein, but is not limited to such.

At operation 306 of FIG. 3, the low-quality product reviews can be weighted differently than high-quality product reviews based on the quality assessment. Note that operation 306 can be implemented in a wide variety of ways. For example in one embodiment, the low-quality product reviews can be given or assigned a first weight or score while and the high-quality product reviews can be given or assigned a second weight or score. In an embodiment, the low-quality product reviews can be assigned a lower weight or score than the weight or score assigned to the high-quality product reviews. In an embodiment, the low-quality product reviews can be assigned a higher weight or score than the weight or score assigned to the high-quality product reviews. In one embodiment, the low-quality product reviews (e.g., “bad review” described herein) can be assigned a first weight while the “fair reviews” of the high quality reviews can be assigned a second weight, the “good reviews” of high quality reviews can be assigned a third weight, and the “best reviews” of high quality reviews can be assigned a fourth weight. It is noted that the first, second, third and fourth weights can progressively increase in weight or can progressively decrease in weight. It is pointed out that operation 306 can be implemented in any manner similar to that described herein, but is not limited to such.

It is noted that in one embodiment, operations 304 and 306 can be combined into one operation. As such, in an embodiment, a threshold can be utilized as part of the combine operations 304 and 306 in order to discern the low-quality product reviews from the high-quality product reviews. In one embodiment, if a threshold is not utilized as part of the combine operations 304 and 306, the scores output from the combine operations 304 and 306 can be used as the weight of the product reviews.

At operation 308, from each of the weighted product reviews, every text segment with an opinion in the review can be identified, and the polarities can be determined of the opinion segments. It is noted that operation 308 can be implemented in a wide variety of ways. For example, operation 308 can be implemented in any manner similar to that described herein, but is not limited to such.

At operation 310 of FIG. 3, for each product feature, a positive opinion set of opinion segments and/or a negative opinion set of opinion segments can be generated. It is pointed out that operation 310 can be implemented in a wide variety of ways. For example, operation 310 can be implemented in any manner similar to that described herein, but is not limited to such.

At operation 312, for each product feature, the one or more weights (or scores) of segments in the positive opinion set and/or negative opinion set can be aggregated, thereby generating an opinion summarization of the product feature. Note that operation 312 can be implemented in a wide variety of ways. For example in one embodiment, given a high-quality product review can be weighted with the score of 0.8 and a low-quality product review can be weighted with a score of 0.2. And given there are two positive opinions, one from the high-quality product review and one from the low-quality product review. Therefore, at operation 312, the 0.8 weight of the positive high-quality product review can be aggregated or added to the 0.2 weight of the positive low-quality product review for a total weight of 1.0. It is pointed out that operation 312 can be implemented in any manner similar to that described herein, but is not limited to such.

At operation 314 of FIG. 2, if there are multiple product features, the opinion summarization for each product feature can be aggregated, thereby generating an opinion summarization of the product. It is pointed out that operation 314 can be implemented in a wide variety of ways. For example, operation 314 can be implemented in any manner similar to that described herein, but is not limited to such. At operation 314, note that if there is a single product feature, the opinion summarization of the product feature generated at operation 312 can also be the opinion summarization of the product.

At operation 316, the opinion summarization of the product can be output or transmitted. Note that operation 316 can be implemented in a wide variety of ways. For example in one embodiment, the opinion summarization of the product can be output or transmitted at operation 316 to a display device to enable viewing of it. In an embodiment, the opinion summarization of the product can be output or transmitted at operation 316 to a computing device via a network. In one embodiment, the opinion summarization of the product can be output or transmitted at operation 316 to a storage device (e.g., memory). Operation 316 can be implemented in any manner similar to that described herein, but is not limited to such. At the completion of operation 316, process 300 can be exited.

It is pointed out that in one embodiment, operation 314 can be omitted from process 300. As such, at operation 316 of this embodiment, one or more of the opinion summarization for each product feature can be output or transmitted. Note that operation 316 of this embodiment can be implemented in a wide variety of ways. For example in one embodiment, one or more of the opinion summarization for each product feature can be output or transmitted at operation 316 to a display device to enable viewing of it. In an embodiment, one or more of the opinion summarization for each product feature can be output or transmitted at operation 316 to a computing device via a network. In one embodiment, one or more of the opinion summarization for each product feature can be output or transmitted at operation 316 to a storage device (e.g., memory). Operation 316 can be implemented in any manner similar to that described herein, but is not limited to such.

It is pointed out that in an embodiment in accordance with the present technology, operations 308, 310 and 312 of method 300 can be referred to as opinion summarization. In an embodiment, operations 308, 310, 312 and 314 of method 300 can be referred to as opinion summarization.

### Example System for Handling Product Reviews

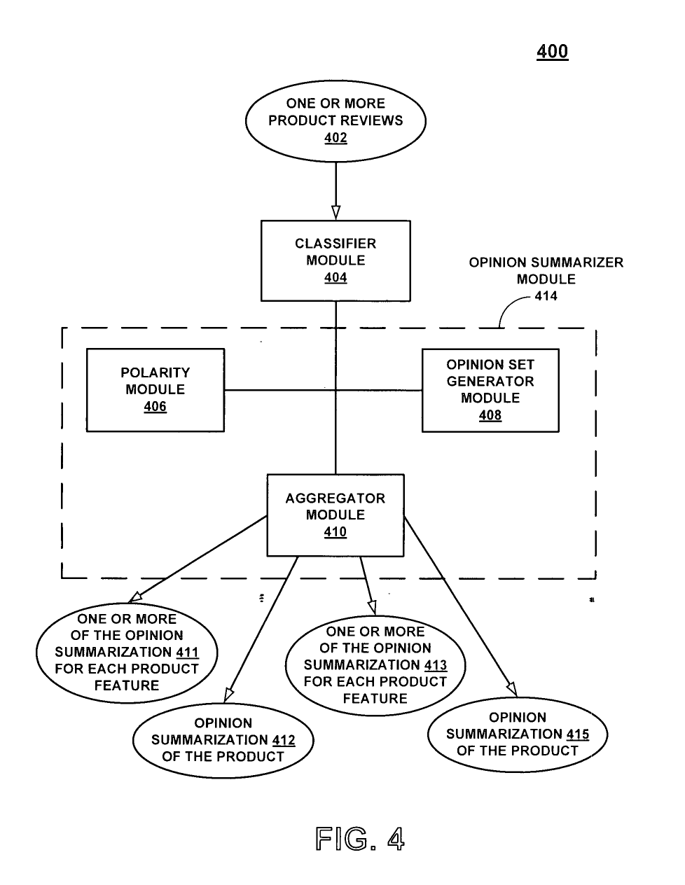

FIG. 4 is a block diagram of an example system 400 for handling product reviews in accordance with an embodiment of the present technology. As shown in FIG. 4, the system 400 can include, but is not limited to, a classifier module 404, a polarity module 406, an opinion set generator module 408, and an aggregator module 410. It is pointed out that the polarity module 406, the opinion set generator module 408, and the aggregator module 410 can be components of an opinion summarizer module 414. Note that system 400 can perform method 200 of FIG. 2 and method 300 of FIG. 3, but is not limited to such.

For purposes of clarity of description, functionality of each of the components in FIG. 4 is shown and described separately. However, it is pointed out that in some embodiments, inclusion of a component described herein may not be required. It is also understood that, in some embodiments, functionalities ascribed herein to separate components may be combined into fewer components or distributed among a greater number of components. It is pointed out that in various embodiments, each of the modules of FIG. 4 can be implemented with software, or firmware, or electronic hardware, or electrical hardware, or any combination thereof.

As shown in FIG. 4, the classifier module 404 can in one embodiment receive or retrieve one or more product reviews from one or more sources. Note that the classifier module 404 can perform this functionality in a wide variety of ways. For example, the classifier module 404 can receive or retrieve one or more product reviews from one or more sources in any manner similar to that described herein, but is not limited to such. Upon receiving or retrieving the one or more product reviews, the classifier module 404 in an embodiment can detect low-quality product reviews within the one or more product reviews. It is noted that the classifier module 404 can detect low-quality product reviews in a wide variety of ways. For example, the classifier 404 can detect low-quality product reviews in any manner similar to that described herein, but is not limited to such. Furthermore, the classifier module 404 can remove or delete any detected low-quality product reviews. The classifier module 404 can then output the remaining high-quality product reviews to the polarity module 406.

From each of the remaining high-quality product reviews, the polarity module 406 can identify every text segment with an opinion in the review, and the polarities can be determined of the opinion segments. The polarity module 406 can then output this information to the opinion set generator module 408. Note that the polarity module 406 can perform the above recited functionality in a wide variety of ways. For example, the polarity module 406 can perform the above recited functionality in any manner similar to that described herein, but is not limited to such.

Within FIG. 4, for each product feature, the opinion set generator module 408 can generate (if available) a positive opinion set of opinion segments and/or a negative opinion set of opinion segments. The opinion set generator module 408 can then output this information to the aggregator module 410. It is pointed out that the opinion set generator module 408 can perform the above recited functionality in a wide variety of ways. For example, the opinion set generator module 408 can perform the above recited functionality in any manner similar to that described herein, but is not limited to such.

For each product feature, the aggregator module 410 can aggregate the numbers (or scores) of segments in the positive opinion set and/or negative opinion set, thereby generating ah opinion summarization 411 of the product feature. If there are multiple product features, the aggregator module 410 can aggregate the opinion summarization 411 for each product feature, thereby generating an opinion summarization 412 of the product. Note that if there is a single product feature, the opinion summarization 411 of the product feature generated by the aggregator module 410 can also be the opinion summarization 412 of the product. The aggregator module 410 can then output the opinion summarization of the product 412 for one or more purposes. In an embodiment, for one or more purposes, the aggregator module 410 can output one or more of the opinion summarization 411 for each product feature. It is noted that the aggregator module 410 can perform the above recited functionality in a wide variety of ways. For example, the aggregator module 410 can perform the above recited functionality in any manner similar to that described herein, but is not limited to such.

Within FIG. 4, it is noted that in an embodiment, upon receiving or retrieving the one or more product reviews, the classifier module 404 can assess the quality of each of the one or more product reviews. It is noted that the classifier module 404 can assess the quality of each of the one or more product reviews in a wide variety of ways. For example, the classifier module 404 can assess the quality of each of the one or more product reviews in any manner similar to that described herein, but is not limited to such. Furthermore, the classifier module 404 can also weight the low-quality product reviews differently than high-quality product reviews based on the quality assessment. Note that the classifier module 404 can weight the low-quality product reviews differently than high-quality product reviews in a wide variety of ways. For example, the classifier module 404 can weight the low-quality product reviews differently than high-quality product reviews based on the quality assessment in any manner similar to that described herein, but is not limited to such. The classifier module 404 can then output the weighted product reviews to the polarity module 406.

From each of the weighted product reviews, the polarity module 406 in an embodiment can identify every text segment with an opinion in the review, and the polarities can be determined of the opinion segments. The polarity module 406 can then output this information to the opinion set generator module 408. It is noted that the polarity module 406 can perform the above recited functionality in a wide variety of ways. For example, the polarity module 406 can perform the above recited functionality in any manner similar to that described herein, but is not limited to such.

Within FIG. 4, for each product feature associated with the weighted product reviews, the opinion set generator module 408 can generate (if available) a positive opinion set of opinion segments and/or a negative opinion set of opinion segments. The opinion set generator module 408 can then output this information to the aggregator module 410. It is pointed out that the opinion set generator module 408 can perform the above recited functionality in a wide variety of ways. For example, the opinion set generator module 408 can perform the above recited functionality in any manner similar to that described herein, but is not limited to such.

For each product feature associated with the weighted product reviews, the aggregator module 410 can aggregate the weights (or scores) of segments in the positive opinion set and/or negative opinion set, thereby generating an opinion summarization 413 of the product feature. If there are multiple product features, the aggregator module 410 can aggregate the opinion summarization 413 for each product feature, thereby generating an opinion summarization 415 of the product. Note that if there is a single product feature, the opinion summarization 413 of the product feature generated by the aggregator module 410 can also be the opinion summarization 415 of the product. The aggregator module 410 can then output the opinion summarization 415 of the product for one or more purposes. In an embodiment, for one or more purposes, the aggregator module 410 can output one or more of the opinion summarization 413 for each product feature. Note that the aggregator module 410 can perform the above recited functionality in a wide variety of ways. For example, the aggregator module 410 can perform the above recited functionality in any manner similar to that described herein, but is not limited to such.

Within FIG. 4, in one embodiment, the classifier module 404 can be coupled to receive or retrieve one or more product reviews 402. Furthermore, it is pointed out that the classifier module 402, the polarity module 406, the opinion set generator module 408, and the aggregator module 410 can each be coupled to one or more of the other modules. Additionally, the aggregator module 410 can be coupled to output the opinion summarization of a product feature 412.

Example embodiments of the present technology for handling product reviews are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for handling product reviews, said method comprising:
detecting a first quality product review from a second quality product review, said first and second quality product reviews are associated with a product;
filtering said first quality product review;
identifying an opinion segment in said second quality product review and determine polarity of said opinion segment;
generating an opinion set with said opinion segment for a product feature; and
aggregating a score of segments in said opinion set for said product feature.

2. The computer-implemented method as recited in claim 1, wherein said detecting further comprises:
utilizing a machine learning technique.

3. The computer-implemented method as recited in claim 1, further comprising:
utilizing said score of segments in said opinion set to produce an opinion summarization of said product feature.

4. The computer-implemented method as recited in claim 1, wherein said detecting further comprises:
utilizing contextual evidence to determine if a second product feature is equivalent to said product feature.

5. The computer-implemented method as recited in claim 1, wherein said detecting further comprises:
utilizing surface string evidence and contextual evidence to determine if a second product feature is equivalent to said product feature.

6. The computer-implemented method as recited in claim 1, wherein said first quality product review does not include a feature of said product and said second quality product review includes a feature of said product.

7. The computer-implemented method as recited in claim 1, wherein said detecting further comprises:
utilizing surface string evidence to determine if a second product feature is equivalent to said product feature.

8. A system for handling product reviews, said system comprising:
a classifier module configured for detecting a first quality product review from a second quality product review;
a polarity module coupled with said classifier module, said polarity module configured for receiving at least said second quality product review from said classifier module, said polarity module configured to identify an opinion segment in said second quality product review and determine polarity of said opinion segment;
an opinion set generator module coupled to said polarity module, said opinion set generator module configured for generating an opinion set with said opinion segment for a product feature; and
an aggregator module coupled to said opinion set generator module, said aggregator module configured for aggregating a score of segments in said opinion set for said product feature.

9. The system of claim 8, wherein said classifier module further configured for receiving said first quality product review and said second quality product review from a web site.

10. The system of claim 8, wherein said aggregator module further configured for utilizing said score of segments in said opinion set to produce an opinion summarization of said product feature.

11. The system of claim 8, wherein said classifier module further configured for filtering said first quality product review.

12. The system of claim 8, wherein said classifier module further configured for utilizing surface string evidence to determine if a second product feature is equivalent to said product feature.

13. The system of claim 8, wherein said classifier module is further configured for utilizing contextual evidence to determine if a second product feature is equivalent to said product feature.

14. The system of claim 8, wherein said wherein said first quality product review includes an incorrect description of said product.

15. A computer-readable medium having computer-executable instructions for performing a method for handling product reviews, said instructions comprising:
assessing a first quality product review and a second quality product review, said first and second quality product reviews are associated with a product;
weighting said first quality product review differently than said second quality product review;
identifying an opinion segment in each of said first and second quality product reviews and determine polarity of each of said opinion segments;
generating an opinion set with said opinion segments for a product feature; and
aggregating a weight of segments in said opinion set for said product feature.

16. The computer-readable medium of claim 15, further comprising:
utilizing said weight of segments in said opinion set to produce an opinion summarization of said product feature.

17. The computer-readable medium of claim 15, wherein said assessing further comprises:
utilizing contextual evidence to determine if a second product feature of said first quality product review is equivalent to said product feature of said first quality product review.

18. The computer-readable medium of claim 15, wherein said assessing further comprises:
utilizing surface string evidence to determine if a second product feature of said first quality product review is equivalent to said product feature of said first quality product review.

19. The computer-readable medium of claim 15, wherein said first quality product review does not include a feature of said product and said second quality product review includes a feature of said product.

20. The computer-readable medium of claim 15, wherein said first quality product review includes an incorrect description of said product.
